(19) United States
(12) Patent Application Publication
(10) Pub. No.: US 2009/0137257 A1
(43) Pub. Date: May 28, 2009

(54) System and Method to Enhance Interaction Between Speakers and Audience

(76) Inventor: Patrick Barber, Madison, CT (US)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 11/944,853

(22) Filed: Nov. 26, 2007

(51) Int. Cl. H04Q 7/20

(52) U.S. Cl. 455/466

(57) ABSTRACT

A system and method of enhancing comprising a real time message receiving system such as SMS text capable of displaying messages from audience members on a screen viewable by a speaker and providing an anonymous opportunity to ask questions and receive real time answers, as well as keeping a record of questions and responses and information about the message senders.

### TECHNICAL FIELD

The present invention relates to computer information systems and more particularly to a method and system of collecting, processing and visually presenting real time inquiries during a conference.

### BACKGROUND OF THE INVENTION

It has been observed that audiences are often inhibited from effectively asking questions and participating in such meetings because of any number of reasons, including speech challenges, fear of speaking before crowds, lack of anonymity, lack of opportunity as well as the lack of significant feedback and response for the speaker on the topic.

Moreover, many questions and questions that go unasked at such conferences are often not able to be answered right away because of time constraints. Answers are often of interest to other attendees as well as those unable to attend the conference but who have invested in the written materials, who also would like the opportunity to ask questions and receive answers.

What is needed is a means by which participants can easily ask questions anonymously using ubiquitous personal technology such as an audience member's own mobile phone. Conference hosts should be able to receive and view questions in real time using ubiquitous technology, such as a web browser and an Internet connection, to be able to present such questions in real time to the speaker(s) for feedback and providing answers, and to provide a forum where questions and written answers may be made available to participants before, during and after a conference. Such a system would ideally provide a means of responding to questioners directly back to their mobile device, or provide a privately viewable response, or provide a widely viewable answer by the entire group or anyone interested in the subject, if the meeting organizer chooses to make the information widely available, and the database to keep records of which mobile number asked which questions and other demographic information.

### BRIEF SUMMARY OF THE INVENTION

The ZUKU system and method provides for the reception of messages over a network from audience members, and displaying the messages in real time on a computer display placed in view of a conference moderator who may then respond to the questions. ZUKU can generate a response message to the sender, which message may contain conference specific information or advertising. Demographics concerning message senders can be collected and maintained. If the network used for sending and receiving messages includes SMS text, hen text addresses (phone numbers) can be collected as well. The system can handle multiple conferences and/or sessions simultaneously by utilizing conference session identifier codes in the questions sent, or by using separate SMS addresses for different conferences and/or sessions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram of a system embodying one or more of the principles of the present invention.

FIG. 2 is high level a flowchart of a system embodying one or more of the principles of the present invention.

### DETAILED DESCRIPTION

In one embodiment, Zuku is a system that collects and presents discussion points between a meeting audience with a moderator through a combination of personal mobile phone units and a browser user interface. The heart of Zuku is the software hub which connects the audience via an SMS short code and aggregates their questions and responses to the moderator through a zero footprint web interface.

In this embodiment, Zuku is a platform that allows members of any live audience, e.g. conference sessions, classroom lectures, company employee meetings, etc to interactively participate in those sessions through communications to the speaker via mobile devices. The senders (Meeting Participant) use their mobile phones/devices to SMS text questions or comments to the speaker, panel or teacher through a moderator (Meeting Admin). The platform will take the text message, format it and present it to the Speaker to both read and answer directly as part of the live session, or to work the question into their presentation. The system sends a response message created by the conference or meeting administrator or zuku administrator that can be used as an advertising or sponsorship message

In addition, the platform provides the speaker with the capability to respond to any unanswered questions in writing and then post the answer to a website for audience members to read. The questions will be sent anonymously and the Meeting Admin will have discretion over which questions, if any, they want to respond to either in the live session or the written responses. After the sender (Meeting Participant) sends a question, Zuku will then send a message back to the sender that may come from the sponsor of the meeting or the lecture.

In addition the platform allows the Meeting Admin to create polls and surveys, and have the Meeting Participants submit their answers with their mobile phone.

In addition the platform allows the administrators to send out a “blast” message to all mobile numbers linked to that meeting, conference or account.

In addition the system links the mobile number to all the meetings, conferences and questions that the Participant has attended to data-mine for relevant ads and messages to be sent to that mobile number if the participant “opts-in.”

An embodiment incorporating one or more of the principles of the present invention is named ZUKU. ZUKU was developed to enhance the effectiveness and the interaction of live meetings—conferences, lectures, employee meetings, panel sessions, speaking events and the like, having typically many audience members and one or a few moderators or lecturers. By gathering (and often responding to) questions essentially anonymously through SMS text messages, the result has been found to be more lively meetings, anonymous hence often more pointed questions, more effective follow up, more satisfaction for all participants, and a targeted way for advertisers to send SMS messages to audience participants either immediately or as follow up.

Users include educational institutions, organizations, and corporations in the education sector—universities, professional schools, and continuing education courses. There are more than 4,000 colleges and universities in the US alone, awarding nearly 17 mm degrees annually, which means there may be as many as 50 mm students enrolled in academic programs every year.

Professional associations and corporate organizations host conferences and meetings for their members. These organizations—of which there are thousands in the US, alone—have dozens of meetings and conferences throughout the year and typically have dozens of meetings and sessions that require/encourage audience participation.

The user environment is primarily a live audience setting: meetings, lectures, continuing education classrooms, panel sessions, employee meetings; any live meeting where increased audience participation would be beneficial, but is potentially hindered by any number of reasons including a desire to stay anonymous, fear of not speaking well, or large audience size. Audience members can ask questions, when they are ready and anonymously, rather than when the floor is opened for questions. The number of senders could be as few as 10-20 or as many as hundreds all sending in questions simultaneously. The time it takes a sender to send a message is just a few seconds; the time a user would be using the application to observe, sort, and manage incoming messages could be as little as 30 minutes and as long as a couple of hours at a time. The time required for the user to respond and publish follow up questions could be a few days to a few weeks. Retaining this information for the user will be useful in planning follow up meetings.

The audience may be live attendees, or may be virtual or combinations of the two, that listen to the speaker. The audience is the larger population that receives information from the speaker; i.e. it can include the live people attending a meeting in a conference, but can also include dozens or hundreds of personnel listening via web cast, satellite or any IP Telephony enabled solution. The program need not necessarily be live—a recorded program can be presented with the opportunity for audience members to ask questions and receive answers from a speaker who is neither attending nor online, but rather receives the questions via Internet and responds as convenient.

The sponsor or advertiser of a conference or meeting may send an acknowledgement message immediately, which may include a sponsor message or sold advertising space. The incoming mobile numbers and their context will be valuable for many months and potentially years. A user is able to capture unique demographic information and associate it with a mobile number.

Using this system, a presenter can receive questions throughout the lecture and manage them as he or she is presenting and then answer them as part of the lecture or during a designated Q & A time. Moreover, questions and responses may be posted on a website to allow for non-attendees to be able to ask questions and to maintain a record of the questions and answers.

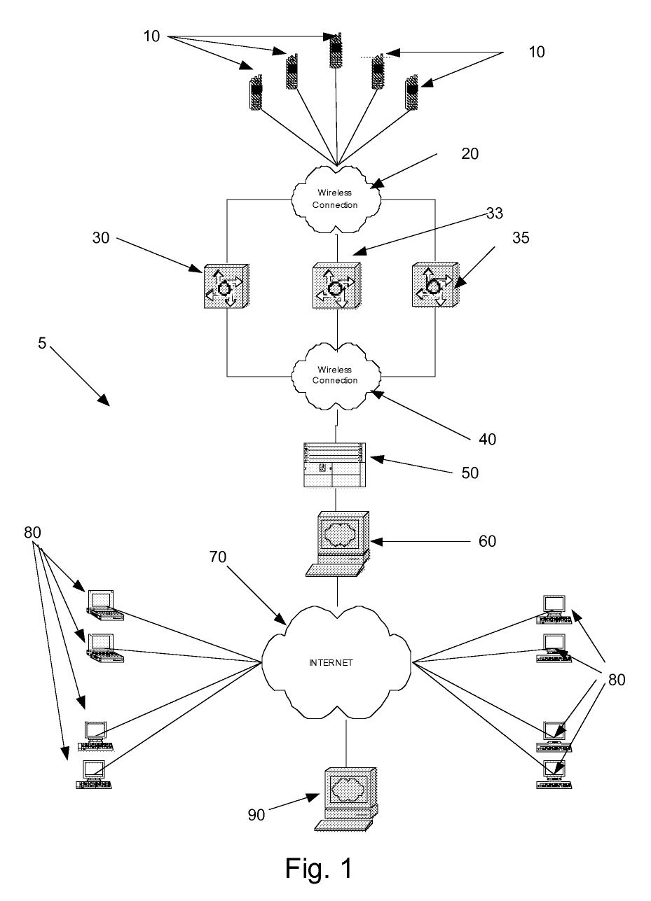

Referring to FIG. 1, a block diagram 5 of the ZUKU system is shown. Users, through cellular phones or other Short Message Service (SMS) capable devices 10 connect through a wireless phone network 20 to any of a variety of SMS capable cell phone network providers 30, 33, 35. These users send an SMS message through networks 30, 33 35 to an SMS gateway 50. The connection may be wireless 40 are wired (not shown).

The message is sent to a number provided by the ZUKU administrator for the duration of the session for which services are to be provided. In one implementation, the ZUKE administrator might have several dozen available numbers to which messages may be sent, one for each conference for which services are to be provided.

The ZUKU administrator gateway 60 routes the incoming message to an Internet web accessible website 80 which may be hosted locally or remotely. The speaker (not shown), who is provided with a computer having Internet access to the website 80 can now see incoming questions and respond appropriately.

As messages are received, a response message may be generated acknowledging receipt of the question and providing a message which may be in the form of paid advertising or a conference sponsor message. The Internet website may be made available to the public during the program, or may be made available at a later time, with question responses posted as available.

ZUKU application servers 90 provide for accounting (such as a fee per message) and backup of incoming messages. Data mining applications may be provided to correlate information contained in the messages and validated cell phone numbers in any way that a user desires.

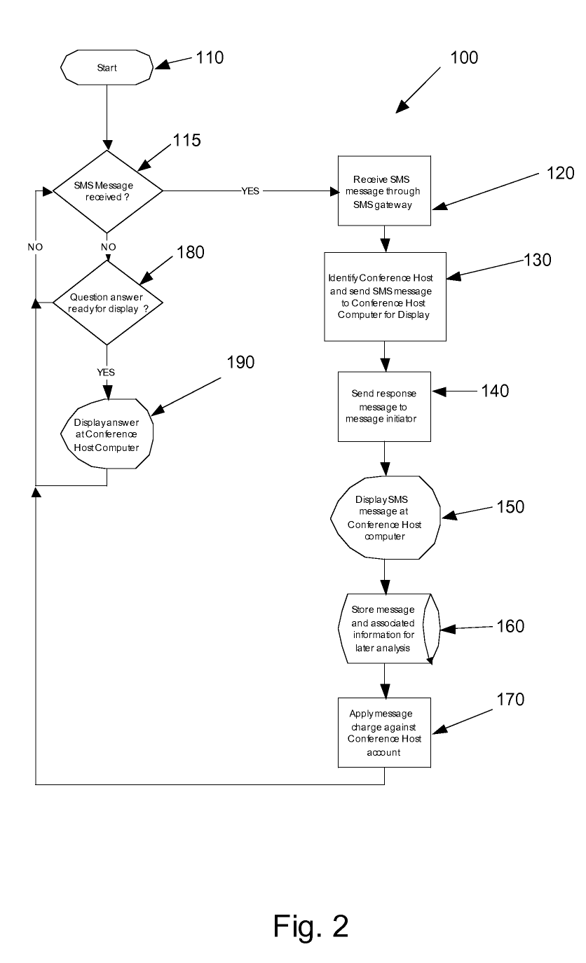

Referring to FIG. 2, a system level flowchart 100 is shown, showing one embodiment according to the principles of the present invention. Begging 110, the system waits for an SMS message to arrive 115. The incoming message may come through a single phone number provided and contain a code identifying the conference, or may come in through one of many phone numbers, each assigned to a particular conference or client. If a message has arrived, it is received through the SMS gateway 120.

Based upon the number through which the SMS message is received or the code contained within the message, the conference host is identified 130. A response message is immediately generated and sent out through the SMA gateway to the message initiator 140. Such message may contain additional information such as conference ads or sold advertising. The incoming message containing a question or comment from the conference attendee is presented for display at the conference host computer 150. This may be accomplished either by local hosting of a website or other means by which the conference host computer may receive and display the question. The conference speaker or panel may be supplied with one or more computers capable of displaying questions as they are received. In one embodiment, display is accomplished by placing the question on an Internet website. Other means for display are well known in the art—the Internet is by no means the exclusive means of display.

The incoming SMS message together with transmission information such as the sending phone number and time of transmission may be stored in a database 160 for later analysis. Additionally, the system may be configured so as to charge a conference host based on the number of messages received 170.

In simplified form, when answers to questions are ready for display 180, it may be displayed as well by the conference administrator. This may include real time updating during the live conference and later responses as available.

It is not necessary that input be limited to SMS messages: in another embodiment, other sources may be included, such as email, transcribed voice mail, manual input of questions by the website 80 administrator or other methods as they may develop. Of course, different communications technologies may offer different and not always identical opportunities for data collection and mining.

While the implementation described above contemplates a central and remote ZUKU administrator, it may also be implemented in a closed system, such as on a University wide network, and need not be implemented across the Internet.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments. Other embodiments are within the scope of the following claims. For example, the steps of the invention can be performed in a different order and still achieve desirable results. The networks utilized need not be nor need not exclusively be the Internet—local area networks may be used to accomplish similar local results.

What is claimed is:

1. A method implemented in a computer program application for providing question handling at a meeting, the method comprising:
providing at least one audience member; said audience member having means for initiating and receiving SMS messages;
providing at least one communications network capable of receiving and forwarding SMS messages;
providing at least one telephone number and further providing at least one SMS gateway capable of receiving and transmitting SMS messages at said at least one telephone number;
receiving at least one SMS message sent from said at least one audience member through said at least one communications network;
providing at least one conference computer and one conference moderator so as to be capable of displaying said SMS message on said conference computer in view of said conference moderator;
providing a link connecting said at least one conference computer, and further forwarding said SMS message through said link to said at least one conference computer and displaying said SMS message on said at least one conference computer.

2. The method of claim 1 further comprising after the said receiving step sending a response SMS message to said at least one audience member.

3. The method of claim 1 in which said link comprises the Internet.

4. The method of claim 1 further comprising providing said at least one SMS message with a conference identifier code.

5. A system for facilitating questions at a conference, comprising
at least one SMS gateway having at least one telephone number connected to a telephone network;
further comprising at least one computer connected to said SMS gateway, said computer being programmed to receive at least one message received by said SMS Gateway; said at least one message containing a conference identifier code and a message initiator address;
further comprising a network, said at least one computer being connected to said network, and further comprising at least one conference website accessible through said network;
said at least one computer programmed so as to be operable for using said conference identifier code to route said at least one message to said conference website and displaying said at least one message thereon.

6. The system of claim 6 further comprising said at least one computer being programmed operable for sending at least one response message to the said message initiator address.

7. The system of claim 6 wherein said at least one response message comprises a conference specific message.

8. The system of claim 5 wherein said network comprises the Internet.
